(19) United States
(12) Patent Application Publication
(10) Pub. No.: US 2008/0248237 A1
(43) Pub. Date: Oct. 9, 2008

(54) Honeycomb Material from Thermofusible Material

(76) Inventors: Heinz Schmidt, Numbrecht (DE); Bernard J. Michels, Howald (LU)

Correspondence Address: MCCARTER & ENGLISH LLP;CITYPLACE I, 185 ASYLUM STREET, HARTFORD, CT, 06103, US

(21) Appl. No.: 11/662,513

(22) PCT Filed: Sep. 7, 2005
(86) PCT No.: PCT/DE2005/001564

§ 371 Date: Feb. 19, 2008

(30) Foreign Application Priority Data
Sep. 10, 2004 (DE) 10 2004 044 278.9

(51) Int. Cl. B32B 3/12; B29C 65/02

(52) U.S. Cl. 428/116; 156/583.1; 156/308.4

(57) ABSTRACT

The invention relates to a honeycomb material. The material is comprised of sections of a thermofusible textile material and the sections are welded together in such a manner as to define cells.

The present invention relates to a honeycomb material with a hexagonal or like structure. Further, the invention relates to an apparatus and a method of manufacturing such a honeycomb material.

Honeycomb materials or elements having a predominantly hexagonal honeycomb structure are widely and increasingly utilized. Reasons therefore are in particular the high pressure resistance and stiffness of such structures.

Honeycomb materials are also known to be used for consolidating soils. In road construction in sand or swamp regions for example, honeycomb foils or fleeces are placed onto the subsoil and the honeycomb cells are filled with stoneware or another suited material. The filled honeycomb materials are thus given a compression strength approaching the compression strength of concrete. Over concrete, the advantage of the honeycomb material however is that it is water permeable.

In order to facilitate filling the building material, the honeycomb cells must have a quite large diameter (preferably from 10 mm to 500 mm, partially even more). The honeycomb material must also be quite strong in order to prevent the upper edges from bending during filling. For these applications, quite thick fleece has proved efficient as the starting material. It is made using a complex sewing process, which involves low productivity and high costs.

The object of the present invention is to provide a honeycomb material that is suited for consolidating the subsoil. The honeycomb material is intended to be low in cost and easy to manufacture. Another object of the present invention is to provide an apparatus and a method for manufacturing such a honeycomb material. It is intended to maintain the original properties of the starting material.

In accordance with the invention, this object is solved by a honeycomb material that is formed from pieces of a thermofusible textile material, said pieces being welded together so as to define cells.

The object is further solved by an apparatus and a method having the features of the independent claims.

Within the scope of this invention, the term textile material includes “woven” and “nonwoven” (fleece) material or also pseudofabric. Preferably, the textile material is at least predominantly formed from a thermofusible plastic material. The share of thermofusible threads thereby depends on the desired compression strength of the honeycomb material and on the starting materials. It is more particularly possible and sensible to form the textile material completely from only one material, more specifically from one plastic material.

As used herein, the term fleece is understood to refer to a continuous layer of threads and/or to continuous layers of threads. Spunbonded fabrics for example, which are continuously made from a spinning mass, are also suited. The scrim is placed onto a conveyor belt and then at need chemically or thermally consolidated. Next, the fleece may be dyed and/or printed. Predominantly polypropylene, but also polyester, polyamide or copolymer threads can be used as the raw material.

Fleeces may also be manufactured by splitting and slivering foils with brushes or spiked rollers, by rubbing, air jet or ultrasound.

The disadvantage of nonwoven fleece is that threads placed onto a conveyor belt during manufacturing are joined together with different closeness related to the cross section of the scrim. This is due to the fact that the scrims are usually pressed together through drums, which involves that the compaction is higher on the outer sides, that is on the sides of the scrims that are turned toward the drum. This again involves that the finished fleece or spunbonded fabric delaminates quite easily, which means that they separate from each other in their central region, related to the cross piece of the scrim.

In accordance with the invention, it is proposed that the honeycomb material be not manufactured using the complex sewing process but using a welding process. This implies that the textile material be weldable, meaning that it has a sufficient share of thermofusible threads. The welding process has the advantage that the textile material continues to consolidate afterwards through the supplied heat.

During the manufacturing of the honeycomb material of the invention, the textile material is supplied in the form of pieces at room temperature to a welding apparatus. Two opposite pieces are melted in parts under the action of the heat supplied, the molten materials being then united and cooled. Cooling may be promoted by supplying cold. In the molten and then cooled regions, the pieces form a monolithic block that is macroscopically homogeneous. The welded pieces are then joined with another piece in the same way, the “weld seams” in the longitudinal direction of the pieces being disposed offset with respect to the already existing weld seams. Next, the joined pieces are pulled apart at adequate temperature to form the honeycomb body to be achieved.

In accordance with the invention, a welding method can be used that relies on the principle of external heating and/or on the principle of internal heating.

Using a method relying on the principle of external welding, heat is introduced from the outside into the pieces with the help of heating elements until the two pieces have reached the melting temperature. Accordingly, the heat is caused to pass through the piece until the faces turned toward each other have been heated sufficiently. The heat may only be transmitted into one piece, but it is also possible to heat both of the pieces to be joined together.

Using a method relying on the principle of internal welding, a heating element is, by contrast, placed between the pieces to be joined. Meaning, the pieces are only heated on the sides that are to be joined together later.

It is however also possible to combine the two methods. In particular with honeycomb materials having large cells and strong or thick textile material, it is sensible to heat the pieces from the outside and from within. The heat then reliably reaches all the threads.

The methods mentioned are given by way of example only; the only factor of importance for manufacturing a honeycomb material of the invention is to form a sufficiently stable welding connection.

It is however essential that the areas that are pressed together during welding are calendered later. The areas located therein between, meaning those later forming the diagonals, however, not. The not calendered areas remain very permeable to water.

In accordance with the invention, the textile material may be formed from amorphous or partially crystallized plastic material.

Through stretching, the macromolecular chains align on the molecular plane and form, in parts, a pseudoatomic lattice because of the energy supplied subsequently. The material crystallizes, resulting in a certain, adjustable degree of crystallization depending on the ratio crystallized moiety to amorphous moiety. As a result, the amorphous moiety may be at least very small.

In accordance with the invention, partially crystallized materials should be welded together according to the principle of internal heating. The advantage of this method is that the heat supplied needs not completely pass through one of the two pieces.

Therefore, in accordance with the invention, the material is first heated to a temperature that is as far as practicable just below the melting temperature of the material (e.g., about 205 to 210° C. with PET). Then, the material is subjected to further short-duration abrupt heating which initiates the melting process. The time period in which the material reaches the melting temperature is preferably less than 1 s, preferably approximately 0.1 s. The slight crystallization occurring afterwards during the subsequent cooling cycle can be controlled just like during the temperature rise. Depending on the demand, a slight subsequent crystallization can be put up with in the weld seam region, although it can be very strongly limited by strong cooling (quenching).

Advantageously, the heating elements may for example comprise a coolant circuit although other means having a like effect may also be envisaged.

As already explained herein above, the honeycomb material is produced, according to the invention, using an apparatus that relies for operation on the principle of internal welding. A welding comb with a plurality of finger-shaped heating elements thereby moves between the pieces to be joined together, heats said pieces under contact until just below the melting temperature at first and is then removed from the pieces.

In an advantageous implementation variant, the heating comb is clamped by the mechanical periphery in an upper position, that is to say, when it is entirely located between the pieces. It is first drawn downward some millimetres in order to improve heat transfer through friction. In this heating phase, the speed is strongly reduced and once the melting process has been initiated it is strongly accelerated. Accordingly, the temperature control or regulation then provides enough energy for the entire height of the foil to reach the melting point in a minimum period of time. Since the heating comb is then removed as quickly as possible, the time for subsequent crystallization to happen is accordingly short.

The process is adapted to the heat diffusion rate. The heating comb remains for example approximately 0.6 seconds between the pieces; the duration of the welding process is of about 0.4 seconds.

The invention will be explained herein after with reference to the accompanying Figs. Other advantages and implementation variants will become apparent from this specification and the appended claims.

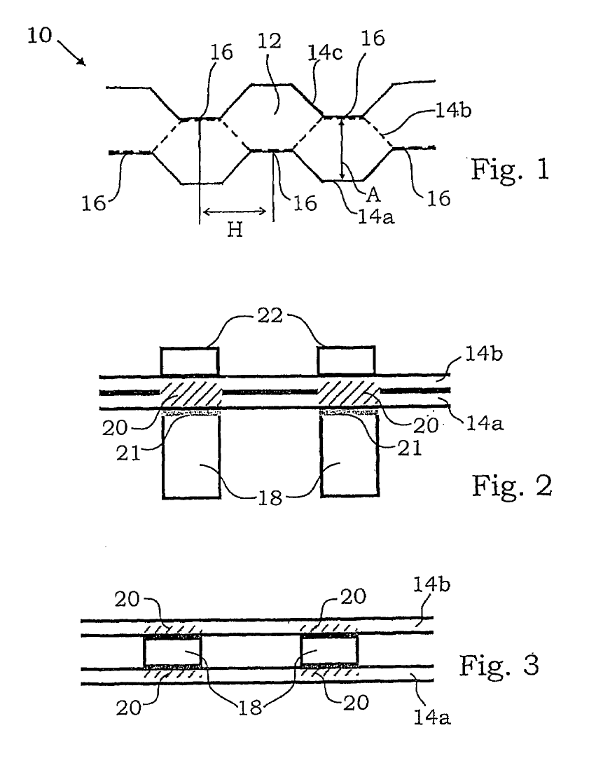

FIG. 1 shows a schematic diagram of a honeycomb material,

FIG. 2 shows a schematic diagram of manufacturing a honeycomb material by heating the foils to be joined together from the outside,

FIG. 3 shows a schematic diagram of manufacturing a honeycomb material by heating the foils to be joined together from within.

FIG. 1 shows a detail of a honeycomb material 10 in a simplified schematic diagram. In the exemplary embodiment at hand, said material has hexagonal cells 12.

The honeycomb material 10 is formed from a textile material 14 or from pieces 14a, 14b, 14c that are joined together. In the exemplary embodiment shown, the three adjacent pieces 14a, 14b, 14c represented are different to facilitate the understanding; this however does not mean that the pieces 14a, 14b, 14c are made from different materials. The pieces 14a, 14b, 14c are in places joined together through connecting pieces 16, said connecting pieces 16 being offset with respect to each other by a distance H from one piece to the other. Depending on the size chosen for the offset H, the shape of the cells 12 may be adapted to desired conditions. H is the distance from one compound center to the other.

There is further shown a cell division A which virtually refers to the height of a cell 12. The cell division A is preferably more than 8 mm.

In accordance with the invention, the textile material 14 is formed from a thermofusible or weldable material.

This heating of the textile material 14 to be welded together may rely on the one side on the principle of internal heating and on the other side on the principle of external heating or on a mixture of both.

FIG. 2 illustrates the principle of external heating. A first piece 14a is brought into contact with a second piece 14b and heating elements 18 are brought into contact with the first piece 14a. The heating elements 18 heat said piece so that the heat is transferred first from the heating elements 18 to the first piece 14a and then from said first piece 14a to the second piece 14b. A heated region 20 forms. Usually, the two pieces 14a, 14b are pressed against holding stamps 22, so that this region is subsequently purposefully calendered. Next, the heating elements 18 are removed, the pieces 14a, 14b are welded together.

Once the two pieces 14 are joined together, a third piece 14c (see FIG. 1) is added to these two pieces. For implementing the honeycomb structure, it is necessary to dispose the connecting pieces 16 between the first piece 14a and the second piece 14b offset relative to the next connecting pieces between for example the second piece 14b and the third piece 14c.

FIG. 3 illustrates the principle of internal heating. The heating elements 18 are interposed between the first piece 14a and the second piece 14b. Through heating, the heated region 20 is formed simultaneously in both foil pieces 14a, 14b, the heat is transferred from the heating elements 18 through the inner faces of the pieces 14a, 14b that are turned toward each other and into said pieces. Generally, heating may occur very fast so that the melting temperature is reached or exceeded very fast, with the heat diffusion rate being taken into consideration. The important point during heating is that the melting temperature of the material is only maintained for a short time in order to avoid or restrict subsequent crystallization. The objective is to physically change only a minimum area of the pieces 14a, 14b, meaning only the smallest possible area of the heated region 20.

Once the two pieces 14a and 14b have reached the welding temperature, the heating elements 18 are removed and the two pieces 14a, 14b are pressed together, for example with the help of movable cylinders (not shown). The movable cylinders may be lined with a soft material so that the pieces 14a, 14b are pressed together gently. The cylinders are only caused to move toward the pieces 14a, 14b so that they do not rub against the material. As a result, there is no fulling effect.

In a particularly advantageous implementation variant, the movable cylinders clamp the heating elements 18 when they are located between the pieces 14a, 14b, that is to say they push the pieces 14a, 14b against the heating elements 18. Once the welding temperature has been achieved, the heating elements 18 are retracted.

Once the two pieces 14a, 14b have been joined together, a third piece 14c (see FIG. 1) is added to these two pieces 14a, 14b. For forming the honeycomb structure, it is hereby necessary that the connecting pieces 16 between the first piece 14a and the second piece 14b be disposed offset relative to the next connecting pieces between the second piece 14b and the third piece 14c for example.

Usually, the bonded pieces 14a, 14b are fanned out to form the final honeycomb material 10. This however may also occur at a later stage, for example on the site at which the honeycomb material will be utilized. Once sufficient pieces 14 have been bonded together, they are mechanically pulled apart for the honeycomb cells to open and the desired honeycomb material 10 to form after cooling. Said material may be brought to suited dimensions using suited methods, fanned out pieces may for example be cut from the thus formed string.

Accordingly, a method of the invention for manufacturing the honeycomb material 10 involves the following steps:
a. providing a thermofusible textile material 14,
b. welding together two pieces 14a, 14b of the thermofusible textile material 14 by connecting a plurality of connecting pieces 16,
c. welding together the bonded pieces 14a, 14b and a next piece 14c using the same method, the new connecting pieces 16 being disposed offset relative to the connecting pieces 16 formed before,
d. repeating step c) ad lib,
e. fanning out the bonded pieces 14a, 14b to form the honeycomb material 10.

The exemplary embodiments illustrated and described herein are only for purposes of illustration and are not to be construed as limiting the invention.

1. A honeycomb material formed from pieces of a thermofusible textile material, the pieces being welded together to form cells.

2. The honeycomb material as set forth in claim 1, wherein the textile material is formed from a nonwoven fleece.

3. The honeycomb material as set forth in claim 1, wherein the textile material is formed from a mechanically woven fabric.

4. The honeycomb material as set forth in claim 1, wherein the textile material is formed from an amorphous material.

5. The honeycomb material as set forth in claim 1, wherein the textile material is formed from a material that is crystallized at least in parts.

6. The honeycomb material as set forth in claim 1, wherein the cells have a cell division (A) of at least 8 mm.

7. An apparatus for manufacturing a honeycomb material as set forth in claim 1, comprising:
heating elements for heating connecting pieces of two pieces that are to be joined together until the piece melting temperature is achieved; and
means for pressing the connecting pieces of the pieces against each other in such a manner that after cooling a permanent connection is maintained.

8. The apparatus for manufacturing a honeycomb material as set forth in claim 7, wherein the heating elements heat the pieces from the outside.

9. The apparatus for manufacturing a honeycomb material as set forth in claim 7, wherein the heating elements:
are interposable between two pieces to be joined together;
heat the connecting pieces of the pieces until the melting temperature is achieved, the heating time being chosen so that the melting temperature is achieved as quickly as possible and that the temperature falls below the melting temperature as quickly as possible; and
means that press the connecting pieces of the pieces against each other in such a manner that after cooling a permanent connection is maintained.

10. The apparatus as set forth in claim 9, wherein movable cylinders are provided for clamping the heating elements when they are located between the pieces and for pushing the pieces against the heating elements, the heating elements being removable once the welding temperature has been achieved.

11. The apparatus as set forth in claim 10, wherein the heating elements are removed quite slowly during a heating phase, the speed of removal being increased when the melting process has been initiated.

12. The apparatus as set forth in claim 7, wherein heating elements heat the pieces to be joined together both from within and from the outside.

13. A method of manufacturing a honeycomb material as set forth in any one of the claim 1, comprising the following steps:
a. providing a thermofusible textile material;
b. welding together two pieces in the region of connecting pieces to form bonded pieces;
c. joining together the bonded pieces and a next foil piece using the same method, new connecting pieces being disposed offset relative to the connecting pieces formed before; and
d. repeating step (c) ad lib.

14. The method as set forth in claim 13 wherein the pieces are heated by heating elements disposed outside.

15. The method as set forth in claim 13 wherein the pieces are heated by heating elements disposed between the pieces.

16. The method as set forth in claim 13 wherein the pieces are heated by heating elements disposed between the pieces and outside.

17. The method as set forth in claim 13, wherein the foil pieces that have been joined together are next fanned out to form the honeycomb material.
